(19) United States
(12) Patent Application Publication
(10) Pub. No.: US 2019/0385520 A1
(43) Pub. Date: Dec. 19, 2019

(54) DISPLAY DEVICE, PIXEL DRIVING METHOD AND PIXEL DRIVING CIRCUIT

(71) Applicant: Wuhan China Star Optoelectronics Semiconductor Dis Display Technology Co., Ltd., Wuhan, Hubei (CN)

(72) Inventor: Caiqin CHEN, Shenzhen, Guangdong (CN)

(21) Appl. No.: 15/746,756

(22) PCT Filed: Dec. 20, 2017
(86) PCT No.: PCT/CN2017/117516

§ 371 Date: Nov. 6, 2018

(30) Foreign Application Priority Data
Jul. 31, 2017 (CN) 201710637672.7

(51) Int. Cl. G09G 3/3233

(52) U.S. Cl. CPC G09G 3/3233; G09G 2320/0233

(57) ABSTRACT

Disclosed are a display device, a pixel driving method and a pixel driving circuit. The pixel driving circuit includes a light emitting element, a control module, a compensation module and a reset module. The light emitting element, the control module and the compensation module are sequentially connected. An input end of the reset module receives a reset signal. An output end of the reset module is connected to an input end of the control module. The control module is connected to a driving terminal, and the compensation module receives a control signal. The control module drives the light emitting element to emit lights when the light emitting element works in a light-emitting state. The compensation module sets the reset signal at high level when the light emitting element works in the light-emitting state. The reset module resets the control module when receiving the reset signal at an effective level.

### RELATED APPLICATIONS

The present application is a National Phase of International Application Number PCT/CN2017/117516, filed on Dec. 20, 2017, and claims the priority of China Application No. 201710637672.7, filed on Jul. 31, 2017.

### FIELD OF THE DISCLOSURE

The disclosure relates to the display technology field, and more particularly to a display device, a pixel driving method and a pixel driving circuit.

### BACKGROUND

Currently, AMOLED (Active-Matrix Organic Light Emitting Diode) display devices are widely used in many kinds of productions. The AMOLED display device includes columns of and rows of pixels. In the AMOLED display device, the current of the OLED elements is provided by a pixel driving circuit including TFTs (Thin Film Transistor). However, TFTs in the pixel driving circuit may have variations with respect to turn-on voltage, mobility or other electronic parameters. These variations will be converted to the uneven current distribution among the OLE elements. The uneven current distribution results in a uniformity decrease of the luminance of the display device, which can be seen by human eyes, which lowers the display performance of the display device.

To deal with the uniformity decrease of the luminance of the display device, a compensation circuit may needed, such as a 7T1C compensation circuit including seven TFTs and one capacitor, a 6T1C compensation circuit including six TFTs and one capacitor, or a 5T2C compensation circuit including five TFTs and two capacitors. In the compensation stage, the turn-on voltage Vth of the TFT is stored by the gate-source voltage Vgs of the TFT. In the light-emitting stage, the current distribution of the display device is more even because the effects due to Vth are cancelled by Vgs−Vth.

However, the start-up voltage and other parameters of the OLED elements vary with time, and the current distribution among the AMOLED pixels having a turn-on voltage compensation is still uneven, which causes a uniformity decrease of the luminance of the display device and thus lowers the display performance of the display device.

### SUMMARY

A technical problem to be solved by the present disclosure is to improve the uniformity and the display performance of a display area of a display device. The present disclosure provides a pixel driving circuit that can improve the uniformity of a display area of a display device.

The pixel driving circuit provided by the present disclosure includes a light emitting element, a control module, a compensation module and a reset module. The light emitting element, the control module and the compensation module are sequentially connected. An input end of the reset module receives a reset signal. An output end of the reset module is connected to an input end of the control module. The control module is connected to a driving terminal, and the compensation module receives a control signal. The control module drives the light emitting element to emit lights when the light emitting element works in a light-emitting state. The compensation module sets the reset signal at high level when the light emitting element works in the light-emitting state. The reset module resets the control module when receiving the reset signal which is an effective signal.

In addition, the present disclosure provides a pixel driving method that can improve the uniformity a display area of a display device.

The pixel driving method provided by the present disclosure includes: driving a light emitting element to emit lights through a control module and setting a reset signal at high level through a compensation module when the light emitting element works in a light-emitting state. In this method, the light emitting element, the control module and the compensation module are sequentially connected, and an input end of the control module is connected to an output end of the reset module. An input end of the reset module receives a reset signal, the control module is connected to a driving terminal, and the compensation module receives a control signal.

Moreover, the present disclosure provides a display device using the above pixel driving circuit that can improve the uniformity a display area of a display device.

To sum up, the light emitting element is driven to emit lights and the reset signal VI is set at high level when the light emitting element works in a light-emitting state. In this manner, a high voltage-level net area can be formed within the display area of the display device such that a uniformity decrease of the luminance of the display device caused by uneven current distribution can be avoided.

### BRIEF DESCRIPTION OF THE DRAWINGS

Accompanying drawings are for providing further understanding of embodiments of the disclosure. The drawings form a part of the disclosure and are for illustrating the principle of the embodiments of the disclosure along with the literal description. Apparently, the drawings in the description below are merely some embodiments of the disclosure, a person skilled in the art can obtain other drawings according to these drawings without creative efforts. In the figures:

FIG. 1 is a schematic diagram of a pixel driving circuit according to an embodiment of the disclosure;

FIG. 2 is a schematic diagram of traces of VI and Vdd of a display device according to an embodiment of the disclosure;

FIG. 3 is a schematic diagram of a pixel driving circuit according to another embodiment of the disclosure;

FIG. 4 is a wave diagram of a pixel driving circuit according to an embodiment of the disclosure;

FIG. 5 is a schematic diagram of a pixel driving circuit according to still another embodiment of the disclosure;

FIG. 6 is a schematic diagram of a pixel driving circuit according to still another embodiment of the disclosure;

FIG. 7 is a schematic diagram of a pixel driving circuit according to still another embodiment of the disclosure; and

FIG. 8 is a flow chart of a pixel driving circuit according to an embodiment of the disclosure.

### DETAILED DESCRIPTION OF PREFERRED EMBODIMENTS

In order to understand the above objectives, features and advantages of the present disclosure more clearly, the present disclosure is described in detail below with references to the accompanying drawings and specific embodiments.

For improving the uniformity and the display performance of a display area of a display device, the present disclosure provides a pixel driving circuit that can improve the uniformity of a display area of a display device.

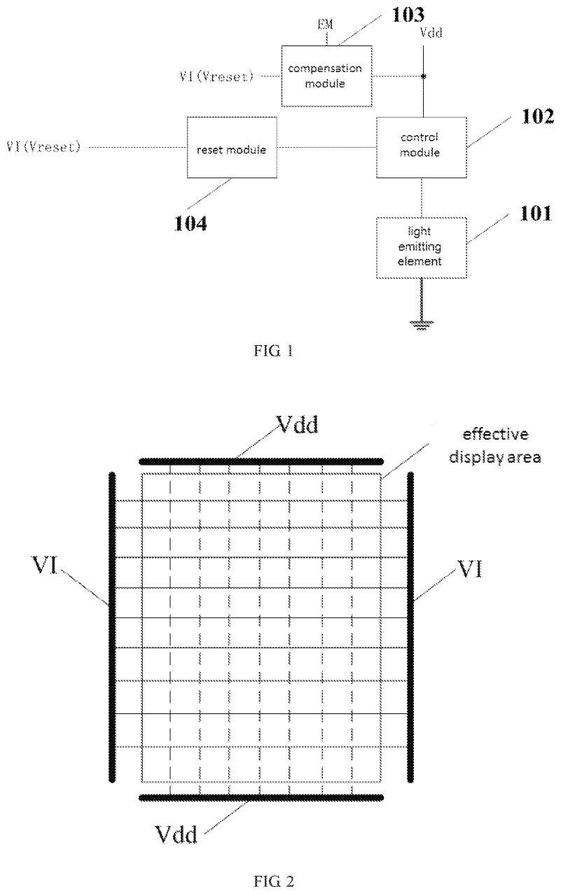

Referring to FIG. 1, a schematic diagram of a pixel driving circuit according to an embodiment of the disclosure is shown. As shown in FIG. 1, the pixel driving circuit includes a light emitting element 101, a control module 102, a compensation module 103 and a reset module 104. The light emitting element 101, the control module 102 and the compensation module 103 are sequentially connected. An input end of the reset module 104 receives a reset signal VI (or Vreset). An output end of the reset module 104 is connected to an input end of the control module 102. The control module 102 is connected to a driving terminal Vdd, and the control module 102 and the compensation module 103 receive a control signal EM. The compensation module 103 receives the reset signal VI (or Vreset. The control module 102 drives the light emitting element 101 to emit lights when the light emitting element 101 works in a light-emitting state. The compensation module 103 sets the reset signal VI (or Vreset) at high level when the light emitting element 101 works in the light-emitting state. The reset module 104 resets the control module 102 when receiving the reset signal VI (or Vreset) which is an effective signal.

In this embodiment, the light emitting element 101 can be an organic light-emitting diode (OLED). For example, the light emitting element 101 can be an active-matrix organic light-emitting diode (AMOLED) or other types of light emitting elements. When the control signal EM is effective, the control module 102 conducts the connection between the driving terminal Vdd and the light emitting element 101 to drive the light emitting element 101 to emit lights. When the control signal EM is effective (i.e. when the light emitting element 101 is driven to emit lights), the compensation module 103 conducts the connection between the reset signal VI (or Vreset) and the driving terminal Vdd to set the reset signal VI (or Vreset) at Vdd which is at high level. Before the light emitting element 101 works in a light-emitting state, the reset module 104 resets the control module 102 to eliminate effects caused by the previous light-emitting process, such that the light emitting element 101 can be ready for the current light-emitting process. Generally, the reset signal VI (or Vreset) can be at low level.

In one embodiment, the output end of the reset module 104 is connected to the input end of the light emitting element 101. Thus, the reset module 104 can reset the light emitting element 101 when receiving the reset signal VI (or Vreset) at an effective level, to eliminate effects caused by the previous light-emitting process, such that the light emitting element 101 can be ready for the current light-emitting process.

In one embodiment, the control module 102 and the reset module 104 include seven TFTs and a pixel compensation circuit having a capacitor (i.e. a 7T1C pixel compensation circuit), six TFTs and a pixel compensation circuit having a capacitor (i.e. a 6T1C pixel compensation circuit), or five TFTs and a pixel compensation circuit having a capacitor (i.e. a 5T1C pixel compensation circuit).

Referring to FIG. 2, a schematic diagram of traces of VI and Vdd of a display device according to an embodiment of the disclosure is shown. As shown in FIG. 2, when the light emitting element 101 works in the light-emitting state, the light emitting element 101 emits lights and the reset signal VI is set at Vdd which is at high level. In the display device, the traces of VI and Vdd, which have different orientations, are set at Vdd which is at high level. In this manner, a high voltage-level area can be formed within the display area of the display device such that a uniformity decrease of the luminance of the display device caused by uneven current distribution can be avoided.

It should be noted that, the orientation of the traces of Vdd and the orientation of the traces of VI are different (i.e. perpendicular to each other) in FIG.2; however, the orientation of the traces of Vdd and the orientation of the traces of VI are not restricted. For example, the orientation of the traces of Vdd and the orientation of the traces of VI can be both horizontal or be both vertical.

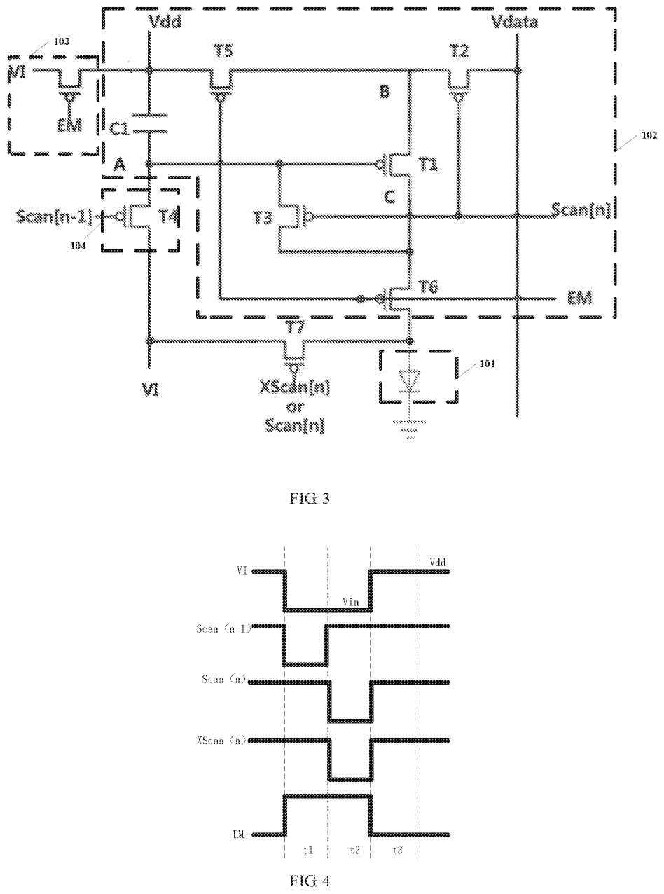

Referring to FIG. 3, a schematic diagram of a pixel driving circuit according to another embodiment of the disclosure is shown. As shown in FIG. 3, the control module 102 and the reset module 104 include seven TFTs and a pixel compensation circuit having a capacitor (i.e. a 7T1C pixel compensation circuit). The seven TFTs are P-type TFTs. Thus, when the gate-source voltage of the TFTs are at low level, the control signal EM is an effective signal and gates and drains of the TFTs are conducted. The control module 102 includes P-type TFTs T1, T2, T3, T5 and T6. The connection relationships among the P-type TFTs T1, T2, T3, T5 and T6 are as shown in FIG. 3, due to these connection relationships, Vth of the P-type TFT T1 can be compensated, and the light emitting element 101 can be controlled to emit lights when the control signal EM is at an effective signal. Herein, when the control signal is at low level, the control signal EM is an effective signal. The compensation module 103 is a P-type TFT. When the control signal EM is an effective signal (i.e. at low level), the compensation module 103 sets VI at Vdd which is at high level so that the connection between VI and Vdd is conducted. The reset module 104 is a P-type TFT T4. The reset module 104 resets the voltage level at the node A at VI (i.e. at low level) when Scan (n-1) is at an effective level (i.e. at low level). The voltage level of the gate of the TFT T1 is at low level. The TFT T1 is a driving TFT. The output end of the reset module 104 is connected to the input end of the light emitting element through a TFT T7, such that when light emitting element 101 can be reset when receiving the reset signal at an effective level. The gate of the TFT T7 is connected to Scan(n) or XScan(n). When the scan signal Scan(n) is an effective signal, the light emitting element 101 is reset (i.e. the anode input end of the OLED).

The pixel driving circuit works in three stages which are the reset stage t1, the compensation stage t2 and the light-emitting stage t3. In the reset staged, the input voltage of the light emitting element 101 is set at 0, and the control module 102 is reset to eliminate effects caused by the previous light-emitting process, such that the light emitting element 101 can be ready for the current light-emitting process. In the compensation stage t2, the threshold voltage Vth of a TFT is stored by the gate-source voltage Vgs. In the light-emitting stage t3, the difference between the threshold voltage Vth and the gate-source voltage Vgs (i.e. Vgs−Vth) is converted to a current. The Vgs includes Vth, so Vth can be cancelled when the difference between the threshold voltage Vth and the gate-source voltage Vgs is converted to a current, such that the current distribution can be even among different pixels. However, considering the parasitic parameter and the driving speed, the threshold voltage Vth cannot be entirely cancelled, so the above compensation is limited. Thus, the current distribution among different pixels may still be uneven, which causes a uniformity decrease of the luminance of the display device and thus decreases the display performance of the display device. To solve this problem, in the light-emitting stage t3, the light emitting element 101 is driven to emit lights and the reset signal VI is set at Vdd which is at high level. In the display device, the traces of VI and Vdd, which have different orientations, are set at Vdd which is at high level. In this manner, a high voltage-level net area can be formed within the display area of the display device such that a uniformity decrease of the luminance of the display device caused by uneven current distribution can be avoided. It should be noted that, the TFTs are P-type TFTs and thus the effective level is a low level.

Referring to FIG. 4, a wave diagram of a pixel driving circuit according to an embodiment of the disclosure is shown. In FIG. 4, “VI(Vreset)” is the reset signal, “Scan(n-1)” is the (n-1)th scan signal, “Scan(n)” is the (n)th scan signal, “XScan(n)” is a signal relevant to Scan(n), and “EM” is the control signal, wherein XScan(n) can be a signal identical to Scan(n). As shown in FIG. 4, in the reset stage t1, Scan(n-1) is at low level, which is the effective level. Thus, the TFT T4 is turned on and the other TFTs are turned off. The voltage level of the node A is set at Vin which can be 0. The reset stage t1 can be considered a preparation for the compensation stage t2. In the compensation stage 12, Scan(n-1) is at high level, which is not the effective level, but Scan(n) and XScan(n) are at low level, which is the effective level. Thus, TFTs T1, T2, T3 and T7 are turned on. The TFT T3 is turned, the gate and the source of the TFT T1 is conducted, so the TFT T1 can be considered a diode of which the conduction direction is from the node B to the node C. The connection between Vdata and the node A is conducted. When the voltage level of the node A is Vdata-Vth, the TFT T1 is turned off. In addition, the TFT T7 is turned on, and the input voltage of the light emitting element 101 is set at Vin (i.e. at low level). The compensation stage t2 can be considered a preparation stage of the light-emitting stage t3. In the light-emitting stage t3, Scan(n-1), Scan(n) and XScan(n) are at high level, which is not the effective level. The control signal is set at low level, which is effective level, and the TFTs T5 and T6 are turned on. The voltage level of the node A is Vdata-Vth, (i.e. a low level), and thus the TFT t1 is turned on such that the connection between Vdd and the light emitting element 101 is conducted. The light emitting element 101 can be an OLED, and in this case, the saturation current flowing through the OLED is:

I_{OLED}=K(Vsg−Vth)²

In the above equation, K is a parameter relevant to T1, Vgs is the gate-source voltage of the TFT T1, Vth is the turn-on voltage of the TFT T1, and Vsg=Vdd−(Vdata−Vth)

Thus, the equation I_{OLED}=K(Vdd−Vdata)² can be obtained.

According to the above equation, the current is not affected by the turn-on voltage Vth. In other words, the current compensation is realized (i.e. the effects brought by the tum-on voltage Vth is eliminated.)

In prior art, in the light-emitting stage, only the voltage level of single-direction traces Vdd is at high level, and thus the current distribution is uneven. In this embodiment, in the light-emitting stage t3, the reset signal VI is at high level, and in the display device, the traces of VI and Vdd, which have different orientations, are set at Vdd which is at high level. In this manner, a high voltage-level net area can be formed within the display area of the display device such that a uniformity decrease of the luminance of the display device caused by uneven current distribution can be avoided.

In another embodiment, the seven TFTs can be N-type TFTs. In this case, the effective level should be a high level (i.e. a current can flow through the source and the drain of the TFT when the voltage level of the gate of the TFT is at high level). In addition, in the eset stage t1, the compensation stage t2 and the light-emitting stage t3, the voltage levels are inverse with respect with Scan(n-1), Scan(n) and XScan(n). However, Vdd, Vdata and Vi remain.

Referring to FIG. 5, a schematic diagram of a pixel driving circuit according to still another embodiment of the disclosure is shown. As shown in FIG. 5, the control module 102 and the reset module 104 include six TFTs and a pixel compensation circuit having a capacitor (i.e. a 6T1C pixel compensation circuit). The control module 102 includes P-type TFTs T1, T2, T3, T5 and T6. The connection relationships among the P-type TFTs T1, T2, T3, T5 and T6 are as shown in FIG. 5. Due to these connection relationships, Vth of the P-type TFT T1 can be compensated, and the light emitting element 101 can be controlled to emit lights when the control signal EM is at an effective signal. Herein, when the control signal is at low level, the control signal EM is an effective signal. The compensation module 103 is a P-type TFT. When the control signal EM is an effective signal (i.e. at low level), the compensation module 103 sets VI at Vdd, which is at high level, so that the connection between VI and Vdd is conducted. The reset module 104 is a P-type TFT T4. The reset module 104 resets the voltage level at the node A at VI (i.e. at low level) when Scan (n-1) is at an effective level (i.e. at low level). The voltage level of the gate of the TFT T1 is at low level. The TFT T1 is a driving TFT. Likewise, the 6T1C pixel compensation circuit also works in three stages which are the reset stage the compensation stage t2 and the light-emitting stage t3, and the waveform diagram of the 6T1C pixel compensation circuit is also shown in FIG. 4. Different from 7T1C pixel compensation circuit, in the reset stage t1, the light emitting element 101 is not reset. The working principle of the 6T1C pixel compensation circuit can be referred to the descriptions relevant to FIG. 3, and thus it is not repeatedly described herein.

In FIG. 5, in the light-emitting stage t3, the light emitting element 101 emits lights, and the reset signal VI is set at Vdd (i.e. at high level). In the display device, the traces of VI and Vdd, which have different orientations, are set at Vdd which is at high level. In this manner, a high voltage-level net area can be formed within the display area of the display device such that a uniformity decrease of the luminance of the display device caused by uneven current distribution can be avoided.

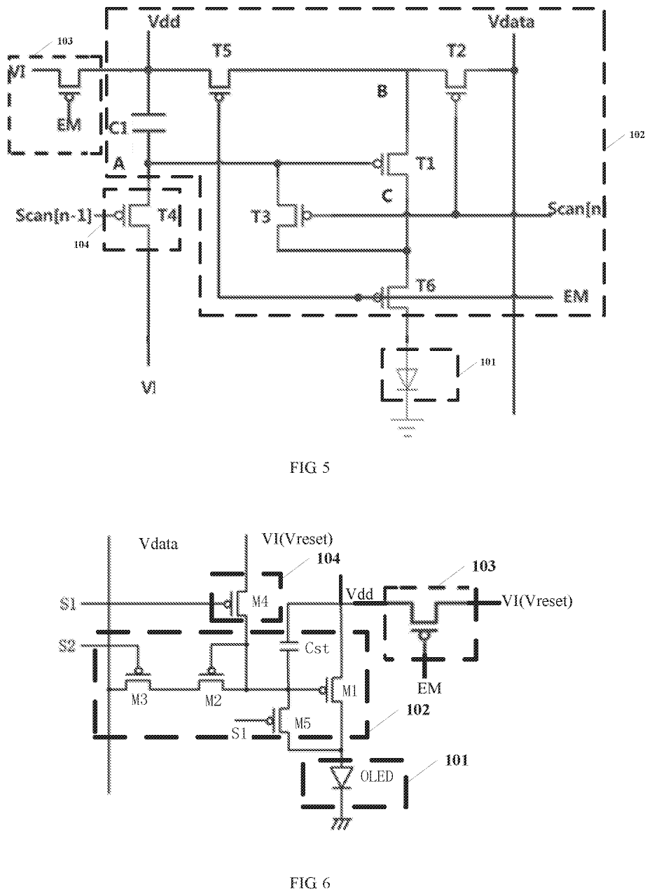

Referring to FIG. 6, a schematic diagram of a pixel driving circuit according to still another embodiment of the disclosure is shown. As shown in FIG. 6, the control module 102 and the reset module 104 include five TFTs and a pixel compensation circuit having a capacitor (i.e. a 5T1C pixel compensation circuit). The control module 102 includes P-type TFTs M1, M2, M3 and M5. The connection relationships among the P-type TFTs M1, M2, M3 and M5 are as shown in FIG. 6. Due to these connection relationships, Vth of the P-type TFT M1 can be compensated, and the light emitting element 101 can be controlled to emit lights in the light-emitting stage t3. The compensation module 103 is a P-type TFT. When the control signal EM is an effective signal (i.e. when the control signal EM is at low level), the compensation module 103 sets VI at Vdd which is a high level so that the connection between VI and Vdd is conducted. The reset module 104 is a P-type TFT T4. The reset module 104 resets the voltage level of the gate of the TFT M1 at Vin, which is a low voltage level, when S1 is at the effective level (i.e. at low level). Herein, the TFT M1 is the driving TFT.

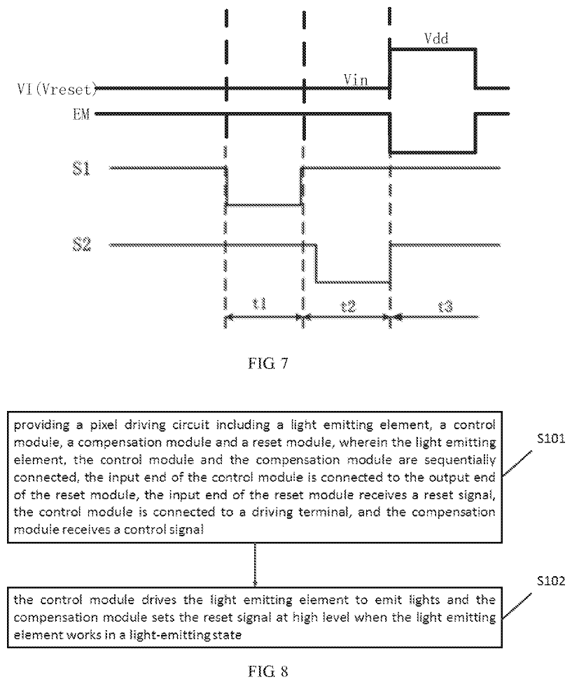

Likewise, the 5T1C pixel compensation circuit also works in three stages which are the reset stage t1, the compensation stage t2 and the light-emitting stage t3. Referring to FIG. 7, a schematic diagram of a pixel driving circuit according to still another embodiment of the disclosure is shown. As shown in FIG. 7, in the reset stage t1 (i.e. a stage for the initialization). Data of one frame is deleted, to avoid affecting data of the next frame. In the reset stage t1, S1 is at low level, S2 is at high level, TFT M1, M4 and MS are turned on, and the voltage at the gate of M1 and the voltage at the anode of the OLED are initialized as Vin, which is generally a low voltage. In the compensation stage t2, S1 is at high level, S2 is at low level, TFT M3 is turned on, and the Vdata is output from a driving chip to the source of M2 through M3. In the reset stage t1, the voltage at the gate of M1 is initialized as Vin, which is a low voltage. When receiving Vdata, the gate of M1 is charged. When the voltage at the gate of M1 is Vdata−Vth, the charging for the gate of M1 is stopped. Vth is the turn-on voltage of M1. In the light-emitting stage t3, S1 and S2 are at high level, TFTs M3, M4 and MS are turned off, and M1 is turned. The voltage of the gate of M1 remains at Vdata−Vth, and thus the current flowing through the OLED is irrelevant to the turn-on voltage Vth of M1. In other words, the current compensation is realized. In the light-emitting stage t3, the compensation module 103 (i.e. the TFT controlled by EM) is turned on, and the VI(Vreset) is set at Vdd, which is a high voltage.

In the light-emitting stage t3, the light emitting element 101 is driven to emit lights, and the reset signal VI is set at Vdd, which is a high voltage. In the display device, the traces of VI and Vdd, which have different orientations, are set at Vdd which is at high level. In this manner, a high voltage-level net area can be formed within the display area of the display device such that a uniformity decrease of the luminance of the display device caused by uneven current distribution can be avoided.

It should be noted that, in addition to the pixel compensation circuits described in the above embodiments, the control module 102 and the reset module 104 can have other circuit configurations, such as a 6T2C pixel compensation circuit including six TFTs and 2 capacitors. The circuit configuration of the control module 102 and the reset module 104 is not restricted as long as the control module 102 and the reset module 104 include the reset signal VI(Vreset) and the reset signal VI(Vreset) is set at high level in the light-emitting stage t3.

For improving the uniformity and the display performance of a display area of a display device, the present disclosure further provides a pixel driving method that can improve the uniformity of a display area of a display device. Referring to FIG. 8, a flow chart of a pixel driving circuit according to an embodiment of the disclosure is shown.

S101: A pixel driving circuit including a light emitting element, a control module, a compensation module and a reset module is provided. The light emitting element, the control module and the compensation module are sequentially connected, the input end of the control module is connected to the output end of the reset module, the input end of the reset module receives a reset signal, the control module is connected to a driving terminal, and the compensation module receives a control signal.

S102: The control module drives the light emitting element to emit lights and the compensation module sets the reset signal at high level when the light emitting element works in a light-emitting state.

The working principle of the pixel driving method can be referred to the descriptions relevant to FIGS. 1-7, and thus it is not repeatedly described.

In the pixel driving method shown in FIG. 8, in the light-emitting stage t3, the light emitting element 101 is driven to emit lights, and the reset signal VI is set at Vdd, which is a high voltage. In the display device, the traces of VI and Vdd, which have different orientations, are set at Vdd which is at high level. In this manner, a high voltage-level net area can be formed within the display area of the display device such that a uniformity decrease of the luminance of the display device caused by uneven current distribution can be avoided.

For improving the uniformity and the display performance of a display area of a display device, the present disclosure further provides a display device. The display device includes a pixel driving circuit described by FIG. 1, FIG. 3, FIG. 5 or FIG. 6 and corresponding descriptions.

The foregoing contents are detailed description of the disclosure in conjunction with specific preferred embodiments and concrete embodiments of the disclosure are not limited to these description. For the person skilled in the art of the disclosure, without departing from the concept of the disclosure, simple deductions or substitutions can be made and should be included in the protection scope of the application.

What is claimed is:

1. A pixel driving circuit, comprising:
a light emitting element;
a control module;
a compensation module; and
a reset module;
wherein the light emitting element, the control module and the compensation module are sequentially connected, an input end of the reset module receives a reset signal, an output end of the reset module is connected to an input end of the control module, the control module is connected to a driving terminal, and the compensation module receives a control signal;
wherein the control module drives the light emitting element to emit lights when the light emitting element works in a light-emitting state;
wherein the compensation module sets the reset signal at high level when the light emitting element works in the light-emitting state;
wherein the reset module resets the control module when receiving the reset signal at an effective level.

2. The pixel driving circuit according to claim 1, wherein the control module drives the light emitting element to emit lights when the control signal is effective.

3. The pixel driving circuit according to claim 1, wherein the compensation module sets the reset signal at high level when the when the control signal is effective.

4. The pixel driving circuit according to claim 1, wherein the output end of the reset module is connected to an input end of the light emitting element, and the reset module resets the light emitting element when receiving the reset signal at the effective level.

5. The pixel driving circuit according to claim 1, wherein the control module and the reset module include seven TFTs and a pixel compensation circuit having a capacitor, six TFTs and a pixel compensation circuit having a capacitor, or five TFTs and a pixel compensation circuit having a capacitor.

6. The pixel driving circuit according to claim 2, wherein the control module and the reset module include seven TFTs and a pixel compensation circuit having a capacitor, six TFTs and a pixel compensation circuit having a capacitor, or five TFTs and a pixel compensation circuit having a capacitor.

7. The pixel driving circuit according to claim 3, wherein the control module and the reset module include seven TFTs and a pixel compensation circuit having a capacitor, six TFTs and a pixel compensation circuit having a capacitor, or five TFTs and a pixel compensation circuit having a capacitor.

8. The pixel driving circuit according to claim 4, wherein the control module and the reset module include seven TFTs and a pixel compensation circuit having a capacitor, six TFTs and a pixel compensation circuit having a capacitor, or five TFTs and a pixel compensation circuit having a capacitor.

9. The pixel driving circuit according to claim 5, wherein the seven TFTs, the six TFTs or the five TFTs are P-type TFTs.

10. The pixel driving circuit according to claim 5, wherein the output end of the reset module is connected to a driving TFT among the TFTs to reset the voltage level of the gate of the driving TFT.

11. A pixel driving method, comprising:
driving a light emitting element to emit lights through a control module and setting a reset signal at high level through a compensation module when the light emitting element works in a light-emitting state;
wherein the light emitting element, the control module and the compensation module are sequentially connected, an input end of the control module is connected to an output end of the reset module, an input end of the reset module receives a reset signal, the control module is connected to a driving terminal, and the compensation module receives a control signal.

12. The pixel driving method according to claim 11, wherein the light emitting element is driven by the control module to emit lights and the reset signal is set at high level through the compensation module when the light emitting element works in the light-emitting state, and the pixel driving method comprises:

13. A display device, comprising a pixel driving circuit according to claim 1.
